(19) United States
(12) Patent Application Publication
(10) Pub. No.: US 2018/0130150 A1
(43) Pub. Date: May 10, 2018

(54) Method and Apparatus for Offering Specialized Local Rates for Travel Products Over the Internet

(71) Applicants: Brian Lloyd Mackenzie, Pomfret ctr, CT (US); Iryna V. Izotova, Pomfret Center, CT (US)

(72) Inventors: Brian Lloyd Mackenzie, Pomfret ctr, CT (US); Iryna V. Izotova, Pomfret Center, CT (US)

(21) Appl. No.: 15/347,827

(22) Filed: Nov. 10, 2016

(51) Int. Cl. G06Q 50/14; G06Q 10/02; G06Q 30/02

(52) U.S. Cl. CPC G06Q 50/14; G06Q 30/0236; G06Q 10/02

(57) ABSTRACT

The OneRez “Prove Your Local” Travel Platform enables travel suppliers to offer discounted or specialized rates to customers who have self-certified that they reside within a geographical distance set by the Travel Supplier or by OneRez on the system. Customers self-certify at the OneRez web site demonstrating the location of their primary residence, and obtain a Local Membership Identification—enabling them to book travel products at the specified local rate from participating travel suppliers.

### FIELD OF INVENTION

The invention relates to a system and related method for travel reservations. More specifically, the present invention relates to a system and related method for travel suppliers to offer specialized local rates to self-certified local customers over an Online Travel Agency (OTA).

### SUMMARY OF INVENTION

For years some travel suppliers have provided discounted rates to customers who can demonstrate that they live locally. The verification, or proof, that the customer lives locally has typically been by the display of the customer's driver's license at the counter of the Travel Supplier. For instance on the Big Island of Hawaii, customers at certain hotels could obtain a discounted local “Kamaina” rate by showing their Hawaii drivers license. Hotels on Cape Cod Massachusetts and elsewhere use similar “rack rate” policies to offer local residents rates which are lower than those offered to traveling customers residing outside of a specified area.

The system and related methods allows the Travel Suppliers to use its normal availability and rate distribution system to distribute its specialized discounted local rate inventory through either a “direct connect” or through the Global Distribution System (GDS) to the OneRez Central Reservation System (CRS). At the same time the system and related methods allows customers to obtain specialized discounted rates from participating travel suppliers simply by demonstrating that their primary residence is local.

The invention also allows for the application to be licensed to the Travel Supplier for their website use. It also relates to the ability of the Travel Supplier to set the Geographic Distance which defines the “Local Rate”.

### BACKGROUND OF INVENTION

The applicant for this patent is Brian MacKenzie, the President and CEO and majority shareholder of OneRez, LLC. OneRez, LLC has been in the internet travel business since 1998, first offering discounted auto rental reservations on the major Internet Travel Sites (OTAs), and more recently operating a system which qualifies Travel Supplier (Hotels and Car Rental) as being Small Business Owned (SBO) according to US Small Business Administration guidelines. From 2009 to 2011 the company operated a similar self-certification system to the one described here, whereby SBO Travel Suppliers identified themselves as SBO as a selection criteria for Government and Business travelers. Through an Agreement with a major GDS travel company, the OneRez. SBO database was integrated into the GDS system as a new property type. The invention allows Travel Agents to select a hotel based on its SBO status during the booking process. The system is further described under the OneRez U.S. Provisional Patent Application No. 61/031,936 filed on 27 Feb. 2008.

The current invention utilizes a similar self-certification process as the previous SBO Travel Supplier platform. This version enables the customer to self-certify that they are Local, rather than having the Travel Supplier certify that they are SBO. The invention is to be utilized exclusively on the OneRez OTA site, to enable Travel Suppliers to offer localized discounted rates to customers who have self-certified that their primary residence is local to the Travel Supplier. The OneRez—“Prove Your Local” platform to distribute discounted local rates is also intended to be available for license to the Travel Suppliers for use on their website.

### BRIEF DESCRIPTION OF DRAWINGS

FIG. 1 shows a diagram of a system in accordance with an exemplary embodiment of the present invention.

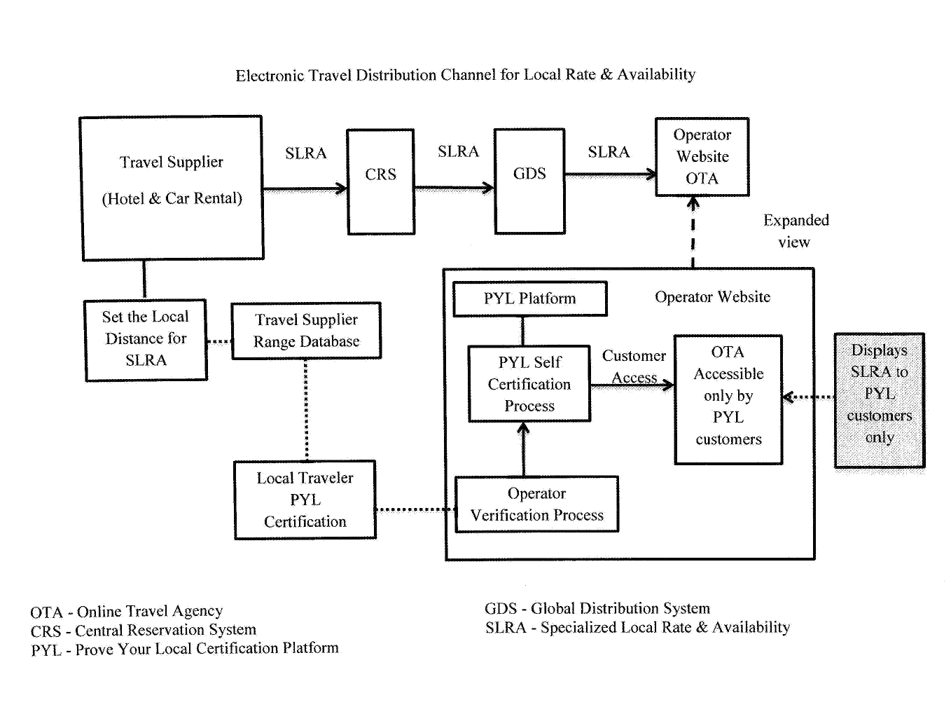

### DETAILED DESCRIPTION OF EXEMPLARY EMBODIMENTS

Many Travel Suppliers would prefer to offer a specialized discounted rate through its internet, and GDS distribution channels to residents which reside local to their hotel, car rental, or other travel business. The ability to ensure that only local residents view and obtain the specialized local rate is useful to the Travel Supplier by not adversely affecting its published rate on the internet, GDS or through other distribution channels.

In one exemplary embodiment, the present invention comprises a system and method for customers to obtain a specialized discounted local rate due to their status as residing in the local area.

I claim:

1) A computer based system to offer specialized discounted rates from Travel Suppliers to customers residing in a local area.

2) The system of claim 1, wherein the customer self-certifies their place of primary residence and the operator of the system verifies the information.

3) The system of claim 1, wherein the customer receives specialized discounted rates from participating Local Travel Suppliers.

4) The system of claim 1, wherein the Travel Suppliers offers specialized local rates on the internet distribution system only to the certified local customer.

5) The system of claim 1, wherein the customer books travel reservations at a discounted specialized rate based on their status as a local resident.

6) The system of claim 1, wherein the Travel Supplier is able to set the geographical distance which defines the local rate.

7) The system of claim 1, wherein the application can be licensed to the Travel Supplier for use on its own booking website.
